(19) United States
(12) Patent Application Publication
(10) Pub. No.: US 2016/0195789 A1
(43) Pub. Date: Jul. 7, 2016

(54) LIQUID CRYSTAL DISPLAY

(71) Applicant: Samsung Display Co., Ltd., Yongin-si (KR)

(72) Inventors: Je Hyeong PARK, Seoul (KR); Eun-Kil PARK, Cheonan-si (KR); Seung Ho YANG, Hwaseong-si (KR)

(21) Appl. No.: 14/875,508

(22) Filed: Oct. 5, 2015

(30) Foreign Application Priority Data
Jan. 5, 2015 (KR) 10-2015-0000686

(51) Int. Cl. G02F 1/1362; G02F 1/1333; G02F 1/1343; G02F 1/1335; G02F 1/1368

(52) U.S. Cl. CPC G02F 1/136286; G02F 1/133514; G02F 1/1368; G02F 1/13439; G02F 1/133345; G02F 1/133512; G02F 2001/136218; G02F 2001/134345

(57) ABSTRACT

A liquid crystal display capable of reducing light leakage and improving contrast ratio is presented. The display includes: a lower display substrate including a thin film transistor and a pixel electrode connected thereto; an upper display substrate facing the lower display substrate; and a liquid crystal layer disposed between the lower display substrate and the upper display substrate, wherein the lower display substrate includes: a data line; a first color filter and a second color filter configured to cover at least a portion of the data line, the first color filter and the second color filter being disposed to overlap each other on the data line; and an opaque shielding electrode disposed on the first and second color filters and overlapping the data line.

### CROSS-REFERENCE TO RELATED APPLICATION

This application claims priority to and the benefit of Korean Patent Application No. 10-2015-0000686 filed in the Korean Intellectual Property Office on Jan. 5, 2015, the entire content of which is incorporated herein by reference.

### BACKGROUND

(a) Technical Field

The present invention relates to a liquid crystal display.

(b) Description of the Related Art

A liquid crystal display is currently one of the most widely used flat panel displays, and includes two display substrates on which field generating electrodes such as a pixel electrode and a common electrode are formed, and a liquid crystal layer interposed between the two display substrates. The liquid crystal display displays an image by generating an electric field on a liquid crystal layer by applying a voltage to the field generating electrodes, determining alignments of liquid crystal molecules of the liquid crystal layer through the generated field, and controlling polarization of incident light.

Among various types of the liquid crystal display, there is a vertically aligned mode liquid crystal display, in which liquid crystal molecules are aligned such that their long axes are perpendicular to display substrates in a state that the electric field is not applied. In the vertically aligned mode liquid crystal display, a pixel electrode and a common electrode are respectively formed in a lower display substrate and an upper display substrate to generate an electric field, and an inclination level of liquid crystal molecules is determined according to the magnitude of the electric field. A method of controlling transmittance by dividing one pixel into two pixels and by differently adjusting voltages of the two subpixels has been proposed to approximate side visibility to front visibility

The liquid crystal display includes light blocking members in order to prevent leakage and reflection of light between pixel electrodes and increase a contrast ratio. The light blocking members are formed on an entire surface of the panel in a matrix form, called a black matrix, and are made of a light blocking material.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a liquid crystal display and a manufacturing method thereof. The display may be capable of increasing the contrast ratio.

In one aspect, the disclosure provides a liquid crystal display including: a lower display substrate including a thin film transistor and a pixel electrode connected thereto; an upper display substrate facing the lower display substrate; and a liquid crystal layer disposed between the lower display substrate and the upper display substrate, wherein the lower display substrate includes: a data line; a first color filter and a second color filter configured to cover at least a portion of the data line, the first color filter and the second color filter being disposed to overlap each other on the data line; and an opaque shielding electrode disposed on the first and second color filters overlapping the data line.

The shielding electrode may be made of a conductive oxide including indium, wherein indium may be precipitated.

The conductive oxide may be indium tin oxide (ITO) or indium zinc oxide (IZO).

A width of the shielding electrode may be wider than that of the data line that is covered by the shielding electrode.

The pixel electrode may include a first subpixel electrode and a second subpixel electrode, the first subpixel electrode may include a first subregion and a second subregion, and the lower display substrate may further include an insulating layer that is disposed on the first subregion and is disposed below the second subregion and the second subpixel electrode.

The shielding electrode may be disposed at a same layer as that of the first subregion.

The first subregion and the second subregion may be connected to each other through a contact hole formed in the insulating layer.

The lower display substrate may further include a light blocking member.

The light blocking member may be disposed to extend in a direction perpendicular to the data line.

The liquid crystal display may further include a column spacer disposed on the light blocking member and made of a same material as that of the light blocking member.

The upper display substrate may include a common electrode that generates an electric field together with the pixel electrode.

A same voltage may be applied to the shielding electrode and the common electrode.

The opaque shielding electrode may extend in the same direction as the data line.

In another aspect, the disclosure provides a manufacturing method of a liquid crystal display, including: forming a data line on a substrate; forming a first color filter and a second color filter that overlap each other and covering the data line; forming a pixel electrode and a precursor of a light blocking electrode on the first and second color filters; and forming an opaque light blocking electrode by performing a plasma treatment on the precursor of the light blocking electrode.

The pixel electrode and the precursor of the light blocking electrode may be made of indium tin oxide (ITO) or indium zinc oxide (IZO).

The forming of the opaque light blocking electrode may include generating haze by causing a material inside the precursor of the light blocking electrode to precipitate.

The precipitated material may be indium.

The pixel electrode may be formed as two layers, and the precursor of the light blocking electrode may be formed together with a lower one of the two layers.

The plasma treatment may be performed in a reducing atmosphere including hydrogen.

The reducing atmosphere may include N₂ and H₂, and a ratio of N₂:H₂ is about 1:3.

In the liquid crystal display according to the exemplary embodiment of the present invention, black by vertical alignment of liquid crystal molecules can be displayed to minimize light leakage by forming the opaque shielding electrode applied with a same voltage as that of the common electrode at the region that overlaps the data line between adjacent pixel electrodes instead of the light blocking member. In the region having steps due to the overlap of the color filters, the shielding electrode also has steps. Accordingly, the liquid crystal molecules may not be completely vertically aligned, thereby generating the light leakage. However, since the shielding electrode is opaque, the contrast ratio can be improved by preventing or minimizing the light leakage. This shielding electrode may be patterned from a transparent conductive oxide layer together with the pixel electrode, and only the shielding electrode is subjected to a plasma treatment to become opaque. As a result, it is not required to provide an additional mask for an opaque shielding electrode.

### BRIEF DESCRIPTION OF THE DRAWINGS

FIG. 1 is a layout view of a liquid crystal display according to an exemplary embodiment of the inventive concept;

FIG. 2 is a cross-sectional view of the liquid crystal display shown in FIG. 1 taken along the line II-II;

FIG. 3 is a layout view of a first portion of a first subpixel electrode of the liquid crystal display of FIG. 1;

FIG. 4 is a layout view of a second portion of a first subpixel electrode of the liquid crystal display of FIG. 1 and a second subpixel electrode;

FIG. 5 is a cross-sectional view of the liquid crystal display shown in FIG. 1 taken along the line V-V;

FIG. 6 is a cross-sectional view of the liquid crystal display shown in FIG. 1 taken along the line VI-VI;

FIG. 7 is a cross-sectional view of the liquid crystal display shown in FIG. 1 taken along the line VII-VII;

FIG. 8 is a cross-sectional view of the liquid crystal display shown in FIG. 1 taken along the line VIII-VIII; and

FIGS. 9, 10, 11, 12, and FIG. 13 are cross-sectional views illustrating a method of forming a shielding electrode according to an exemplary embodiment of the inventive concept.

### DETAILED DESCRIPTION OF THE EMBODIMENTS

The inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

A liquid crystal display according to an exemplary embodiment will now be described in detail with reference to the accompanying figures.

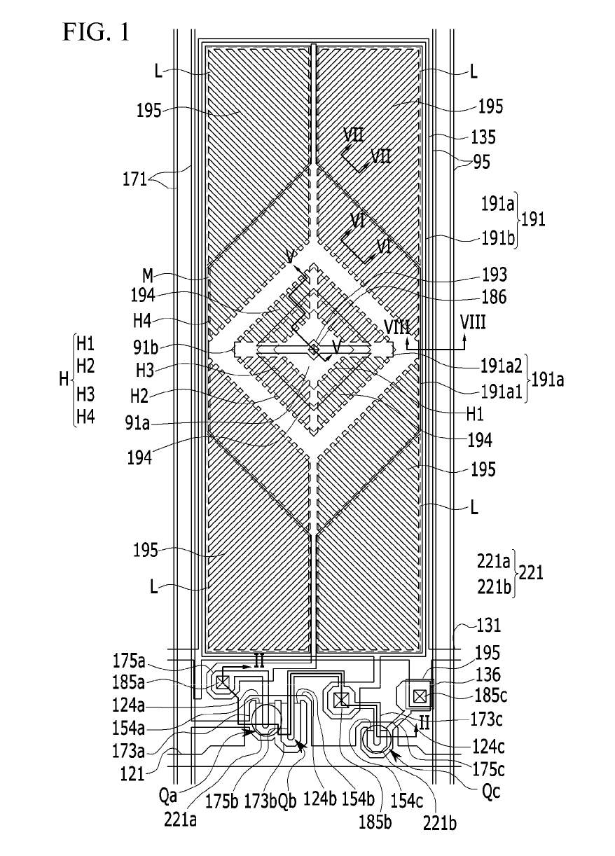

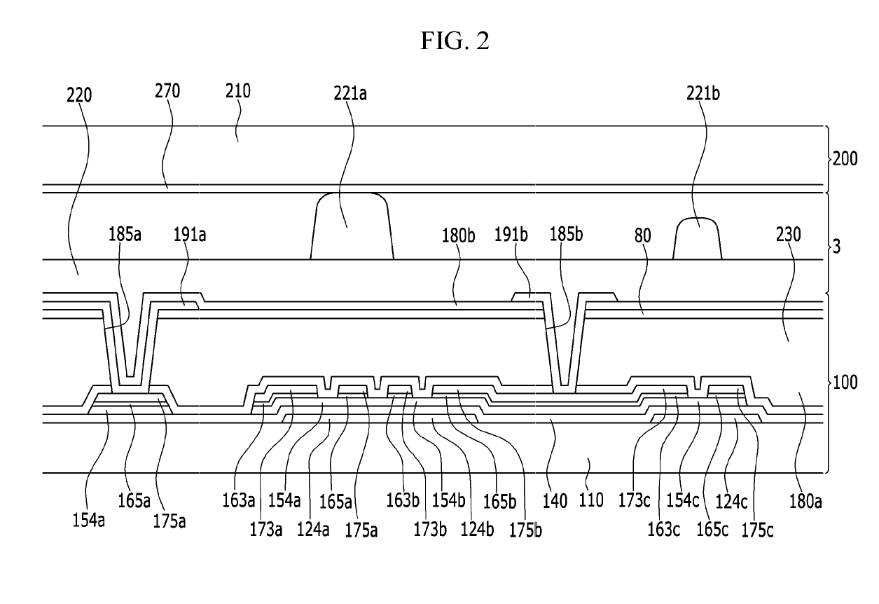

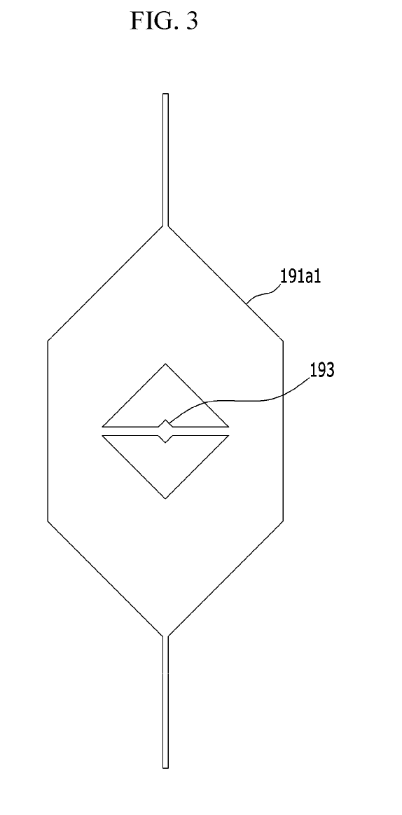

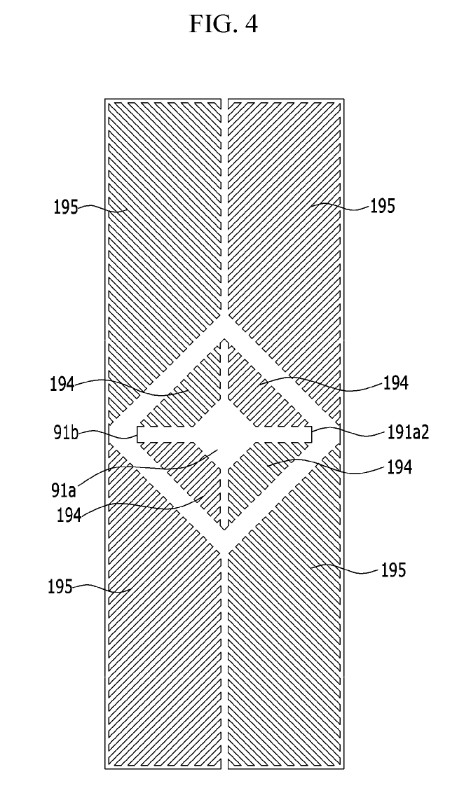

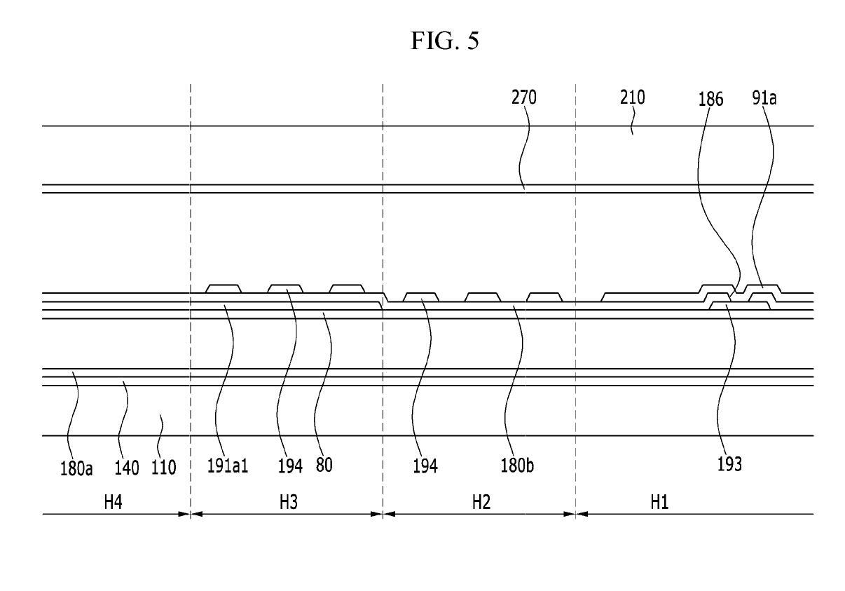

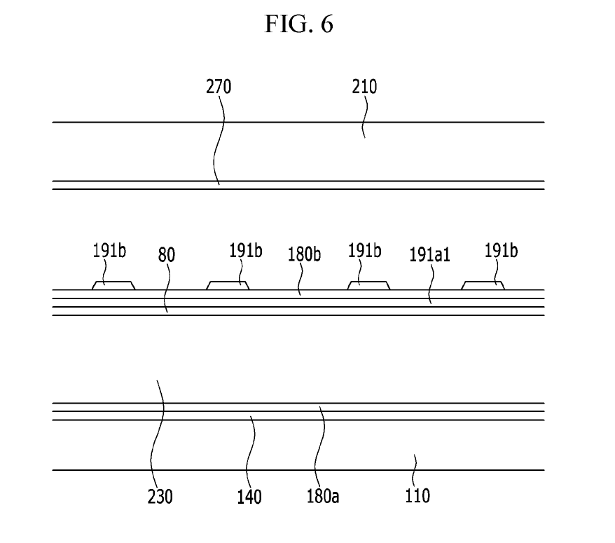

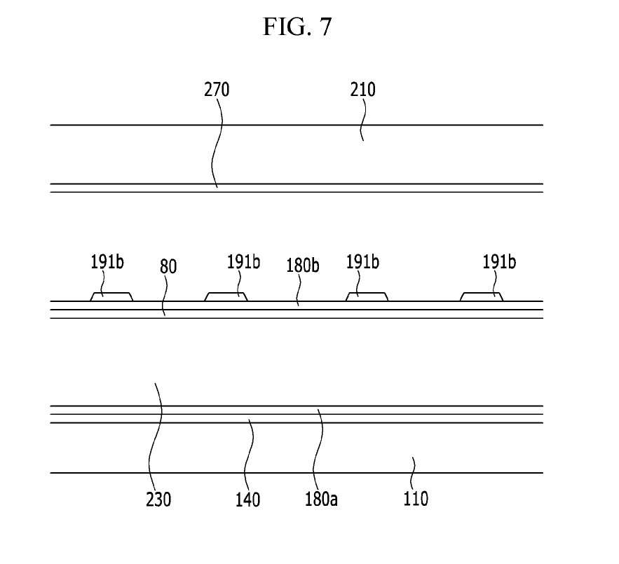

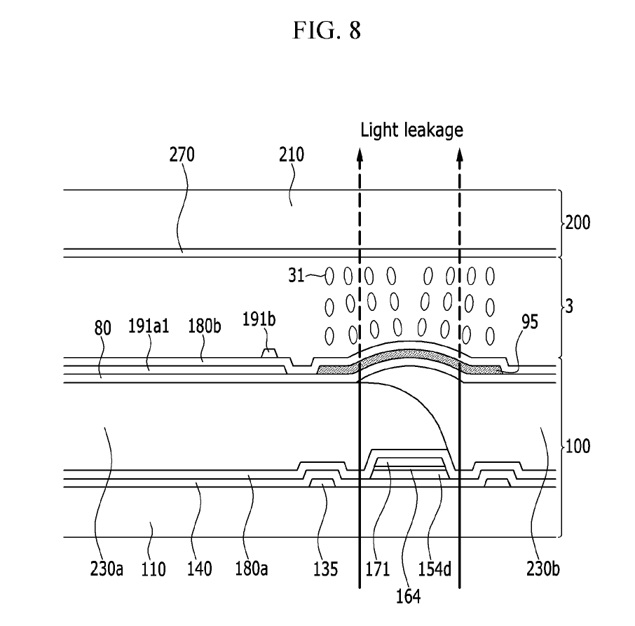

FIG. 1 is a layout view of a liquid crystal display according to an exemplary embodiment. FIG. 2 is a cross-sectional view of the liquid crystal display shown in FIG. 1 taken along the line II-II. FIG. 3 is a layout view of a first portion of a first subpixel electrode of the liquid crystal display of FIG. 1. FIG. 4 is a layout view of a second portion of a first subpixel electrode of the liquid crystal display of FIG. 1 and a second subpixel electrode. FIG. 5 is a cross-sectional view of the liquid crystal display shown in FIG. 1 taken along the line V-V. FIG. 6 is a cross-sectional view of the liquid crystal display shown in FIG. 1 taken along the line VI-VI. FIG. 7 is a cross-sectional view of the liquid crystal display shown in FIG. 1 taken along the line VII-VII. FIG. 8 is a cross-sectional view of the liquid crystal display shown in FIG. 1 taken along the line VIII-VIII.

Referring to FIG. 1 and FIG. 2, the liquid crystal display according to the exemplary embodiment of the present invention includes a display panel including a lower display substrate 100 and an upper display substrate 200 which are disposed to face each other and are bonded to each other, and a liquid crystal layer 3 formed between the two display substrates 100 and 200.

First, the lower display substrate 100 will be described.

A gate line 121, a reference voltage line 131, and a first storage electrode line 135 are formed on a lower substrate 110 formed of an insulator such as transparent glass or plastic. The gate line 121 is disposed to mainly extend in a horizontal direction to serve to transfer a gate signal including a gate-on voltage and a gate-off voltage.

The gate line 121 includes a wide end (not illustrated) for connection with a first gate electrode 124a, a second gate electrode 124b, a third gate electrode 124c, and another layer or an external driving circuit.

The reference voltage line 131 may be disposed to extend in parallel with the gate line 121, and has an extension 136 which is connected to a third drain electrode 175c to be described below. The reference voltage line 131 includes the storage electrode 135 which encloses a pixel area.

A gate insulating layer 140 is formed on the gate line 121, the reference voltage line 131, and the first storage electrode line 135.

A first semiconductor 154a, a second semiconductor 154b, and a third semiconductor 154c, and a semiconductor stripe 154d which may be made of amorphous silicon, crystalline silicon, or the like are formed on the gate insulating layer 140.

A plurality of ohmic contacts 163a, 163b, 163c, 165a, 165b, and 165c are formed on the first semiconductor 154a, the second semiconductor 154b, and the third semiconductor 154c, and an ohmic contact 164 is formed on a semiconductor stripe 154d. In the case the semiconductors 154a, 154b, 154c, and 154d are oxide semiconductors, the ohmic contacts may be omitted.

A data conductor including a first source electrode 173a and a second source electrode 173b, a third source electrode 173c, a first drain electrode 175a, a second drain electrode 175b, the third drain electrode 175c, and a data line 171 is formed on the ohmic contacts 163a, 163b, 163c, 165a, 165b, 165c and 164. The second drain electrode 175b is connected to the third source electrode 173c. The data line 171 is disposed between pixel electrodes that are horizontally adjacent to each other, to mainly extend in a vertical direction, and serves to transfer a data voltage that is applied to pixel electrodes 191.

The first gate electrode 124a, the first source electrode 173a, and the first drain electrode 175a constitute a first switching element Qa serving as a thin film transistor together with the first semiconductor 154a, and a channel of the thin film transistor is formed at a semiconductor portion between the first source electrode 173a and the first drain electrode 175a. Similarly, the second gate electrode 124b, the second source electrode 173b, and the second drain electrode 175b constitute second switching element Qb together with the second semiconductor 154b, and a channel thereof is formed at a semiconductor portion between the second source electrode 173b and the second drain electrode 175b. The third gate electrode 124c, the third source electrode 173c, and the third drain electrode 175c constitute a third switching element Qc together with the third semiconductor 154c, and a channel thereof is formed at a semiconductor portion between the third source electrode 173c and the third drain electrode 175c.

A first passivation layer 180a is formed on the data conductor and the exposed portion of the semiconductors 154a, 154b, and 154c. In this case, the first passivation layer 180a may be formed of an inorganic insulator such as a silicon nitride or a silicon oxide.

Color filters 230 are formed on the first passivation layer 180a. Each pixel may display one of primary colors of red, green, and blue by the color filters 230. Referring to FIG. 8, first and second color filters 230a and 230b having different colors may be formed in adjacent pixels. For example, the first color filter 230a may be a color filter having one color of blue, green, and red, and the second color filter 230b may be a color filter having another color thereof. The first and second color filters 230a and 230b are disposed to overlap each other along the data line 171. As a result, portions of the first and second color filters 230a and 230b which are formed on the data line 171 are not flatly formed, but form a slightly convex surface.

A capping layer 80 may be disposed on the color filters 230. The capping layer 80 serves to prevent the color filters 230 from coming off and reduces contamination of the liquid crystal layer caused by an organic material such as a solvent that may flow from the color filters 230a/b, in order to prevent defects such as after-images which may be caused when a screen is driven.

A shielding electrode 95 and a first subregion 191a1 of a first subpixel electrode 191a are formed on the capping layer 80.

Referring to FIG. 3, the first subregion 191a1 of the first subpixel electrode 191a has a planar shape including a horizontal connector positioned in the center of the pixel area and four parallel sides positioned to surround the horizontal connector. Extensions 193 are formed at a central portion of the horizontal connector. Further, the first subregion 191a1 of the first subpixel electrode 191a pixel area has protrusions that vertically extend along a vertical central portion of the pixel area. The first subregion 191a1 of the first subpixel electrode 191a is positioned at a portion of the pixel area.

Referring to FIG. 8, the shielding electrode 95 is formed along the data line 171 positioned between the pixel electrodes 191 that are adjacent to each other in the horizontal direction to overlap the data line 171. The shielding electrode 95 may be formed to cover the data line 171 to prevent light reflection caused by the data line 171. To that end, the shielding electrode 95 may be formed to have a width that is wider than that of the data line 171. The same voltage as the voltage applied to the common electrode 270 is applied to the shielding electrode 95. Accordingly, no electric field is generated between the shielding electrode 95 and the common electrode 270, and thus the liquid crystal molecules positioned therebetween are always in a vertically aligned state.

Since a screen is displayed as black by the vertical alignment of the liquid crystal molecules, it is possible to prevent light leakage between the adjacent pixel electrodes 191 and the light reflection caused by the data line 171 without relying on a light blocking member such as black matrix overlapping with the data line. However, the surfaces of the first and second color filters 230a and 230b are not formed to be flat since they overlap with each other on the data line 171 (see FIG. 8). Hence, the shielding electrode 95, which is formed on the non-flat portion of the color filter 230b, is also not flat and is formed conformably over the overlapped portion of the color filters 230a and 230b. As a consequence, the liquid crystal molecules may not be completely vertically aligned and may be slightly inclined in this area over the data line 171. Even when the liquid crystal molecules are slightly inclined, the light emitted from the light source is blocked by the data line 171 at a portion that is overlaps with the data line 171, thereby preventing light leakage. However, the light leakage may be generated at a portion shown by broken-line arrows in FIG. 8, which does not overlap the data line 171. Thus, the contrast ratio of the liquid crystal display may be deteriorated.

According to an exemplary embodiment, the shielding electrode 95 is made opaque to minimize light leakage. Herein, being opaquely formed may indicate a state of having light transmittance that is lower than that of a transparent electrode made of a transparent conductive oxide (TCO). For example, a milky haze is formed in the shielding electrode 95 by a plasma treatment where the shielding electrode 95 is made of a transparent conductive oxide such as indium tin oxide (ITO) or indium zinc oxide (IZO). When the shielding electrode 95 is opaque, a small amount of light passes through the shielding electrode 95. This can offset the light leakage which may be caused by the incomplete vertical alignment of the liquid crystal molecules. As an opacity level of the shielding electrode 95 is increased, light leakage can be further reduced.

A second passivation layer 180b is formed on the capping layer 80, the first subregion 191a1 of the first subpixel electrode 191a, and the shielding electrode 95.

A second subpixel electrode 191b and a second subregion 191a2 of the first subpixel electrode 191a are formed on the second passivation layer 180b.

Referring to FIG. 4, the second subregion 191a2 of the first subpixel electrode 191a is positioned at a central portion of one pixel to have an entirely rhombic shape. The second subregion 191a2 includes a plate-shaped portion 91a positioned at a central portion, a cross-shaped stem 91b extending from the plate-shaped portion 91a, and a plurality of first branch electrodes 194 extending from the plate-shaped portion 91a and the cross-shaped stem 91b. The first branch electrodes 194 are positioned to extend in four different directions.

The second subpixel electrode 191b includes outer stems formed to surround the outer circumference of the pixel electrodes and a plurality of second branch electrodes 195 extending from the outer stems. The second branch electrodes 195 are positioned to extend in four different directions.

A first contact hole 185a is formed in the first passivation layer 180a and the capping layer 80 to partially expose the first drain electrode 175a, and a second contact hole 185b is formed in the first passivation layer 180a, the capping layer 80, and the second passivation layer 180b to partially expose the second drain electrode 175b. Further, a third contact hole 186 is formed in the second passivation layer 180b to expose the central portion of the first subregion 191a1 of the first subpixel electrode 191a.

The first subregion 191a1 of the first subpixel electrode 191 is connected to the first drain electrode 175a through the first contact hole 185a, and the second subpixel electrode 191b is connected to the second drain electrode 175b through the second contact hole 185b. The second subregion 191a2 of the first subpixel electrode 191a is connected to the extensions 193 of the first subregion 191a1 of the first subpixel electrode 191a through the third contact hole 186 formed in the second passivation layer 180b.

The first subpixel electrode 191a and the second subpixel electrode 191b respectively receive data voltages from the first drain electrode 175a and the second drain electrode 175b through the first contact hole 185a and the second contact hole 185b.

The shielding electrode 95 and the pixel electrode 191 including the first subpixel electrode 191a and the second subpixel electrode 191b may be made of a transparent conductive material such as indium tin oxide (ITO) or indium zinc oxide (IZO). In the shielding electrode 95, indium that is in the precursor is made to precipitate by plasma treatment so that the transparent conductive material turns hazy. In the present exemplary embodiment, the case that the shielding electrode 95 is formed at the same layer as one of two layers of pixel electrodes is illustrated. Alternatively, when the pixel electrode is formed as a single layer, the shielding electrode 95 may be formed at the same layer as or at a layer that is different from the pixel electrode.

A light blocking member 220 is formed on the second passivation layer 180b. The light blocking member 220 is also called a black matrix BM. The light blocking member 220 may be formed substantially in parallel with gate line 121. In this case, the light blocking member 220 is formed to cover a gap between the pixel electrodes 191 that are vertically adjacent to each other in a plan view, thereby preventing light leakage or reflection therebetween. No light blocking member 220 may be formed between the pixel electrodes 191 that are horizontally adjacent to each other in a plan view. In other words, the light blocking member 220 may be disposed to extend in the horizontal direction that is perpendicular to the data line 171 in a plan view, and may not overlap with the data line 171 disposed between the pixel electrodes 191 that are horizontally adjacent to each other in a plan view.

According to another exemplary embodiment, the light blocking member 220 may be formed in the upper display substrate 200.

A column spacer 221 is formed on the light blocking member 220. The column spacer 221 may include a main column spacer 221a which is relatively high and a sub-column spacer 221b which is relatively low. The column spacer 221 serves to maintain a cell gap which is a distance between the lower display substrate 100 and the upper display substrate 200.

The column spacer 221 may be made of the same material as that of the light blocking member 220. For example, the column spacer 221 and the light blocking member 220 may be simultaneously formed by forming a layer having a predetermined thickness on a photoresist with a material into which chromium-based metal materials or carbon-based organic materials are mixed, and patterning the layer with a halftone mask or a slit mask. According to another exemplary embodiment, the column spacer 221 may be formed in the upper display substrate 200.

The upper display substrate 200 will be described hereinafter. A common electrode 270 is formed on an upper substrate 210 serving as an insulation substrate. The common electrode 270 may be formed of a transparent conductor such as ITO or IZO. The common electrode 270 may receive a common voltage. The common electrode 270 is formed on the entire surface of the upper substrate 210, and the common electrodes 270 of the pixels PX are connected to each other. According to another exemplary embodiment, the upper display substrate 200 may include a color filter disposed between the upper substrate 210 and the common electrode 270, for example.

An alignment layer (not shown) is formed on an internal surface of each of the display substrates 100 and 200, and the alignment layers may be vertical alignment layers.

A polarizer (not shown) is formed on an external surface of each of the display substrates 100 and 200, and the polarizers may be perpendicular to each other.

The liquid crystal layer 3 disposed between the lower display substrate 100 and the upper display substrate 200 includes liquid crystal molecules 31 having negative dielectric anisotropy. The liquid crystal molecules are aligned such that long axes thereof are perpendicular to the planar surfaces of the two display substrates 100 and 200 in a state in which no electric field is generated. As a result, incident light is blocked and does not pass through the crossed polarizers in the state of having no electric field.

Hereinafter, a driving method of a liquid crystal display according to an exemplary embodiment will be briefly described.

When a gate-on voltage is applied to the gate line 121, the gate-on voltage is applied to the first gate electrode 124a, the second gate electrode 124b, and the third gate electrode 124c to turn on the first switching element Qa, the second switching element Qb, and the third switching element Qc. Accordingly, a data voltage applied to the data line 171 is applied to the first subpixel electrode 191a and the second subpixel electrode 191b through the first switching element Qa and the second switching element Qb, respectively. In this case, the same voltage is applied to the first subpixel electrode 191a and the second subpixel electrode 191b. However, the voltage applied to the second subpixel electrode 191b is divided by the third switching element Qc that is connected in series with the second switching element Qb. Thus, the voltage applied to the second subpixel electrode 191b is smaller than the voltage applied to the first subpixel electrode 191a.

Although it has been described that the third switching element Qc is connected to the second switching element Qb in series, the present disclosure is not limited thereto, and may be applied to all the cases in which the magnitude of a voltage applied to the second subpixel electrode 191b is smaller than that of a voltage applied to the first subpixel electrode 191a.

Referring again to FIG. 1, one pixel area of the liquid crystal display according to the exemplary embodiment is configured with a first region H in which a portion of the first subregion 191a1 of the first subpixel electrode 191a and the first subpixel electrode 191a are disposed, a second region M in which a portion of the first subregion 191a1 of the first subpixel electrode 191a and a portion of the second subpixel electrode 191b are disposed, and a third region L in which a portion of the second subpixel electrode 191b is disposed. Further, the first region H includes a first small region H1, a second small region H2, a third small region H3, and a fourth small region H4.

The first region H, the second region M, and the third region L are each configured of four regions along a direction in which the first branch electrodes 194 or the second branch electrodes 195 extend.

Next, the first region H, the second region M, and the third region L which are included in one pixel area of the liquid crystal display according to the exemplary embodiment will be described with reference to FIG. 5 to FIG. 7.

Referring to FIG. 5, the first region H of one pixel area of the liquid crystal display according to the present exemplary embodiment is divided into the first small region H1, the second small region H2, the third small region H3, and the fourth small region H4. In the first small region H1, the plate-shaped portion 91a of the second subregion 191a2 of the first subpixel electrode 191a connected to the extensions 193 of the first subregion 191a1 of the first subpixel electrode 191a is disposed. In the second small region H2, portions of the first branch electrodes 194 of the second subregion 191a2 of the first subpixel electrode 191a disposed on the second passivation layer 180b are disposed. In the third small region H3, a portion of the first subregion 191a1 of the first subpixel electrode 191a and portions of the first branch electrodes 194 of the second subregion 191a2 of the first subpixel electrode 191a are disposed to overlap each other with the second passivation layer 180b therebetween.

In the fourth small region H4, a portion of the first subregion 191a1 of the first subpixel electrode 191a is disposed.

In the first small region H1 of the first region H of the pixel area, the common electrode 270 and the plate-shaped portion 91a of the second subregion 191a2 of the first subpixel electrode 191a generate an electric field, and the liquid crystal molecules of the liquid crystal layer 3 are arranged by the electric field.

In the second small region H2 of the first region H of the pixel area, the common electrode 270 and portions of the first branch electrodes 194 of the second subregion 191a2 of the first subpixel electrode 191a generate an electric field, and the liquid crystal molecules of the liquid crystal layer 3 are arranged by the electric field.

In the third small region H3 of the first region H of the pixel area, the liquid crystal molecules of the liquid crystal layer 3 are arranged by an electric field which is generated between the common electrode 270 and portions of the first branch electrodes 194 of the second subregion 191a2 of the first subpixel electrode 191a, and an electric field generated between the common electrode 270 and the first subregion 191a1 of the first subpixel electrode 191a.

In the fourth small region H4 of the first region H of the pixel area, the common electrode 270 and a portion of the first subregion 191a1 of the first subpixel electrode 191a generate an electric field, and the liquid crystal molecules of the liquid crystal layer 3 are arranged by the electric field.

In this case, the liquid crystal molecules of the liquid crystal layer 3 positioned at the second small region H2 and the third small region H3 of the first region H are inclined in different directions by a fringe field generated by an edge of the first branch electrodes 194 of the second subregion 191a2 of the first subpixel electrode 191a positioned at the second small region H2 and the third small region H3 of the first region H. Specifically, a horizontal component of the fringe field generated by the first branch electrodes 194 is substantially parallel with sides of the first branch electrodes 194, and thus the liquid crystal molecules are inclined in a direction that is parallel with a length direction of the first branch electrodes 194. The liquid crystal molecules positioned at the first small region H1 and the fourth small region H4 of the first region H are inclined in a direction that is parallel with the direction in which the liquid crystal molecules positioned at the second small region H2 and the third small region H3 of the first region H are formed.

As described above, the first subregion 191a1 of the first subpixel electrode 191a and the second subregion 191a2 of the first subpixel electrode 191a are connected to each other through the third contact hole 186, and thus receive the same magnitudes of voltages. Accordingly, in the first region H, the electric field of the first small region H1 has the greatest magnitude, and the electric field of the third small region H3 has the second greatest magnitude. Next, the electric field of the second small region H2 has the third greatest magnitude, and the electric field of the fourth small region H4 has the smallest magnitude.

Referring to FIG. 6, in the second region M of one pixel area of the liquid crystal display, a portion of the first subregion 191a1 of the first subpixel electrode 191a and portions of the second branch electrodes 195 of the second subpixel electrode 191b are disposed to overlap each other with the second passivation layer 180b. Accordingly, the liquid crystal molecules of the liquid crystal layer 3 are arranged by an electric field generated between the common electrode 270 and the first subregion 191a1 of the first subpixel electrode 191a disposed between the second branch electrodes 195 of the second subpixel electrode 191b and an electric field generated between the second branch electrodes 195 of the second subpixel electrode 191b and the first subregion 191a1 of the first subpixel electrode 191a, as well as an electric field generated between the common electrode 270 and the second branch electrodes 195 of the second subpixel electrode 191b.

In this case, the liquid crystal molecules of the liquid crystal layer 3 positioned at the second region M are inclined in four different directions by a fringe field generated by an edge of the second branch electrodes 195. Specifically, a horizontal component of the fringe field generated by the second branch electrodes 195 is substantially parallel with sides of the second branch electrodes 195, and thus the liquid crystal molecules are inclined in a direction that is parallel with a length direction of the second branch electrodes 195.

Since the magnitude of a voltage applied to the second subpixel electrode 191b is smaller than that of a voltage applied to the first subpixel electrode 191a, the magnitude of an electric field generated at the second region M is relatively small as compared with the magnitude of the electric field generated at the first region H.

Next, referring to FIG. 7, in the third region L of one pixel area of the liquid crystal display, an electric field is generated by the common electrode 270 of the second branch electrodes 195 of the second subpixel electrode 191b. In this case, the liquid crystal molecules of the liquid crystal layer 3 positioned at the third region L are inclined in four different directions by a fringe field generated by an edge of the second branch electrodes. Specifically, a horizontal component of the fringe field generated by the second branch electrodes 195 is substantially parallel with sides of the second branch electrodes 195, and thus the liquid crystal molecules are inclined in a direction that is parallel with a length direction of the second branch electrodes 195.

Since the magnitude of a second voltage applied to the second subpixel electrode 191b is smaller than that of a first voltage applied to the first subpixel electrode 191a, an electric field applied to the liquid crystal layer disposed at the first region H has the greatest magnitude, and an electric field applied to the liquid crystal layer disposed at the third region L has the smallest magnitude. The second region M is affected by the electric field of the first subpixel electrode 191a disposed below the second subpixel electrode 191b, and thus the magnitude of the electric field applied to the liquid crystal layer positioned at the second region M is smaller than that of the electric field applied to the liquid crystal layer disposed at the first region H, and is greater than that of the electric field applied to the liquid crystal layer positioned at the third region L. Further, in the first region H, the electric field of the first small region H1 has the greatest magnitude, the electric field of the third small region H3 has the second greatest magnitude, the electric field of the second small region H2 has the third greatest magnitude, and the electric field of the fourth small region H4 has the smallest magnitude.

As such, in the liquid crystal display according to an exemplary embodiment, one pixel area is divided into the first region H at which the first subpixel electrode to which a relatively high first voltage is applied is disposed, the second region M at which a portion of the first subpixel electrode and a portion of the second subpixel electrode to which a relatively low second voltage is applied are disposed to overlap each other with an insulating layer therebetween is disposed, and the third region L at which the second subpixel electrode to which the relatively low second voltage is applied is disposed. Further, the first region H at which the first subpixel electrode is disposed is divided into the first small region H1, the second small region H2, the third small region H3, and the fourth small region H4 at which electric fields having different magnitudes are respectively generated. As a result, electric fields applied to the liquid crystal molecules positioned at the first region H, the second region M, and the third region L, and the first small region H1, the second small region H2, the third small region H3, and the fourth small region H4, respectively have different magnitudes, and thus the respective liquid crystal molecules are differently inclined, thereby accomplishing different luminance at each region. Accordingly, it is possible to smoothly adjust the change of transmittance according to grays by dividing one pixel area into three regions having different luminance and dividing a first region into four subregions. As a result, accurate gray expression can be accomplished while approximating side visibility to front visibility by preventing the transmittance from being sharply changed even at low grays and high grays on a side surface according to gray variation.

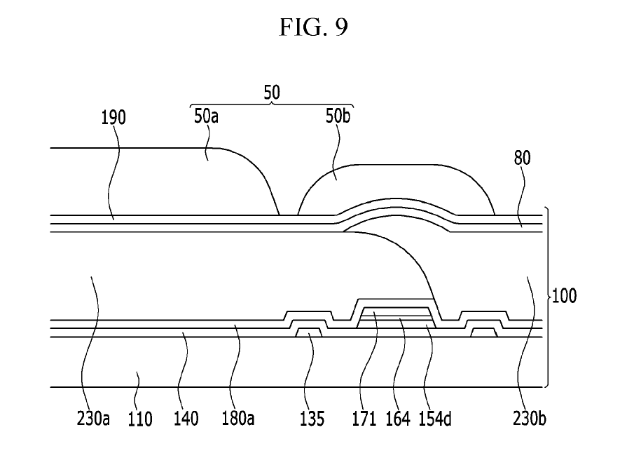

A method of forming the shielding electrode 95 according to an exemplary embodiment of the present invention will now be described with reference to FIG. 9 to FIG. 13.

FIG. 9 to FIG. 13 are cross-sectional views illustrating a method of forming a shielding electrode according to an exemplary embodiment of the present invention.

Specifically, FIG. 9 to FIG. 13 illustrate some of a manufacturing process of the lower display substrate 100 corresponding to cross-sections of the liquid crystal display shown in FIG. 1 taken along the line VIII-VIII. Referring to FIG. 9, the data line 171 is formed, the capping layer 80 is formed on the first and second color filters 230a and 230b that are overlapped with each other at a region that is positioned to overlap the data line 171, and a transparent electrode layer 190 is formed on the capping layer 80. The transparent electrode layer 190 may be made of a transparent conductive oxide (TCO) including indium such as indium tin oxide (ITO) or indium zinc oxide (IZO). A photoresist is formed on the transparent electrode layer 190 and is patterned to form a photoresist film pattern 50. The photoresist film pattern 50 includes a relatively thick first portion 50a formed to cover a portion at which the first subregion 191a1 of the first subpixel electrode 191a will be formed at the first transparent electrode layer 190, and a relatively thin second portion 50b formed to cover a portion at which the shielding electrode 95 will be formed. The thickness difference of the first photoresist film pattern 50 can be formed by adjusting an amount of light irradiated with a mask or by using a reflow method. In the case where the light amount is adjusted, a slit pattern, a lattice pattern, or a translucent layer may be formed on the mask.

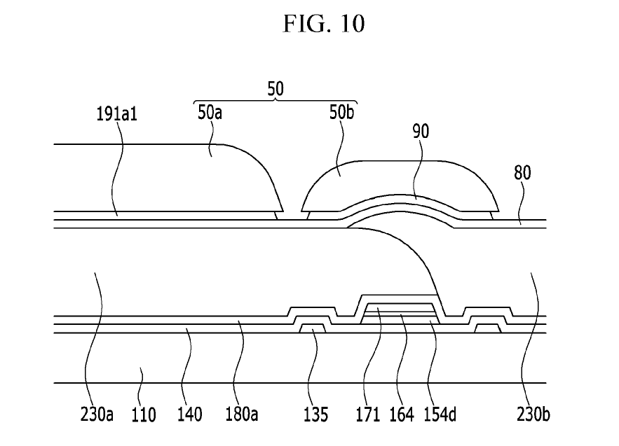

Referring to FIG. 10, the first subregion 191a1 of the first subpixel electrode 191a and a precursor 90 of the shielding electrode are formed by etching the transparent electrode layer 190 using the photoresist film pattern 50 as a mask.

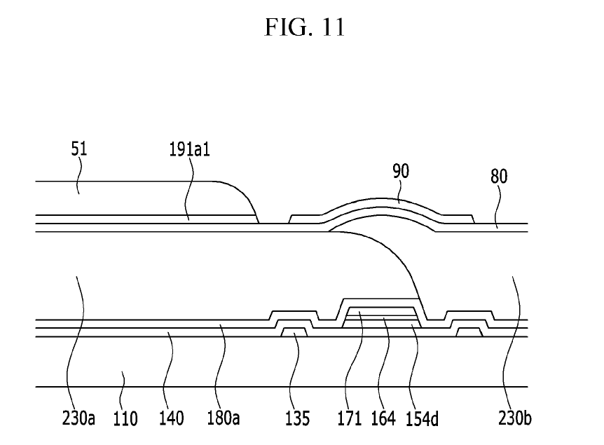

Thereafter, referring to FIG. 11, the second portion 50b having the relatively thin thickness of the photoresist film pattern 50 is received by etching back. In this case, the first region 50a is also etched and a width and a height thereof are decreased into a second photoresist pattern 51. As a result, the precursor 90 of the shielding electrode is exposed, but the first subregion 191a1 of the first subpixel electrode 191a is shielded by the second photoresist film pattern 51.

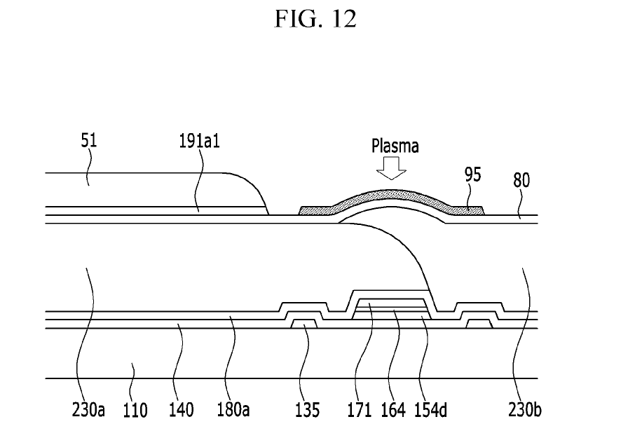

Referring to FIG. 12, a plasma treatment for generating haze is performed in the precursor 90 of the shielding electrode. The haze indicates a phenomenon in which a film becomes opaque due to a material such as indium that is precipitated by the plasma treatment in a reduction atmosphere. The precipitated material scatters light to make the film opaque, e.g., milky. As a result, the transparent precursor 90 of the shielding electrode becomes the shielding electrode 95. A gas used in the plasma treatment may include hydrogen (H2).

It is seen that precipitation of indium is strongly performed when hydrogen radicals exist through a H2 plasma treatment. Further, as temperature is increased, the reaction can be easily performed. The plasma power may be 3 kW or more, and the plasma treatment may be performed for 10 seconds or more for sufficient reaction.

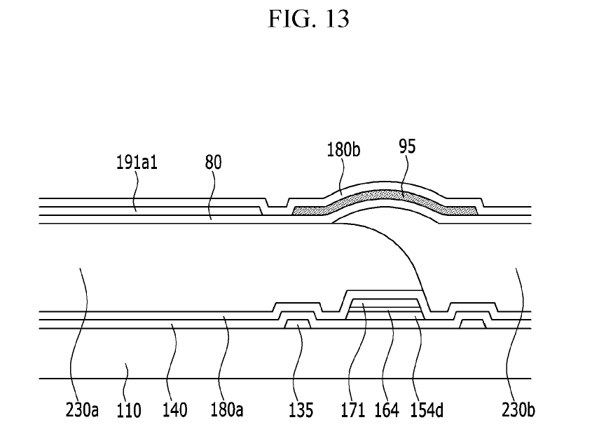

Referring to FIG. 13, the second photoresist film pattern 51 is removed by using a stripper, thereby exposing the first subregion 191a1 of the first subpixel electrode 191a, and a next step is performed to form the second passivation layer 180b.

As such, by using photoresist film patterns having different thicknesses, it is possible to selectively perform the plasma treatment to form the shielding electrode 95 without additionally using a mask in the process of forming the first subregion 191a1 of the first subpixel electrode 191a. The plasma treatment for generating haze may be performed with chemical vapor deposition (CVD) equipment, a dry etching chamber, or the like. The haze can be generated without increasing the number of steps by performing a plasma pre-treatment together when the second passivation layer 180b is formed.

Table 1 shows reduction of black luminance of a portion at which the shielding electrode 95 which is overlapped with the data line 171 is to be formed and an increase of the contrast ratio. When the reduction of the black luminance caused by haze is calculated, the reduction of 40% leads to the increase of about 7.11% in the contrast ratio, and the reduction of 60% leads to the increase of about 11.06% in the contrast ratio. Accordingly, it is seen that the contrast ratio is improved by the action of the shielding electrode 95 that becomes opaque by generating haze.

TABLE 1

| Shielding electrode | | | | |
|---|---|---|---|---|
| forming portion | | | | |
| Black luminance | | Black | CR predicted | |
| reduction | H₂/N₂ | luminance | value | CR increment |
| 0% | 0 | 0.078 | 4333 | |
| 40% | 3 | 0.073 | 4642 | 7.11% |
| 60% | — | 0.070 | 4813 | 11.06% |
| 80% | — | 0.068 | 4997 | 15.31% |
| 100% | — | 0.065 | 5196 | 19.90% |

Table 2 shows plasma pre-treatment condition and corresponding luminance reduction. The luminance reduction amount is varied according to a ratio of N₂ to H₂, and particularly it is seen that the luminance reduction is 40% in a plasma treatment PT having a ratio of N₂:H₂ that is 1:3. As the amount of H₂ is increased, it is possible to additionally accomplish black luminance reduction.

TABLE 2

| | Pre-treatment | | | | | | | |
|---|---|---|---|---|---|---|---|---|
| | condition | Time | Power | Spacing | Pressure | N₂ | H₂ | Brightness |
| #1 | Ref. (PT skip) | — | — | — | — | — | — | 100% |
| #2 | N₂/H₂ PT (1:3) | 30 | 5 kw | 1000 | 1500 | 12,000 | 36,000 | 60% |
| #3 | N₂/H₂ PT (20:1) | 30 | 5 kw | 1000 | 1000 | 80,000 | 4000 | 96% |
| #3 | N₂/H₂ PT (10:1) | 30 | 5 kw | 1000 | 1000 | 80,000 | 8000 | 95% |

While this disclosure has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims and the above disclosure.

What is claimed is:

1. A liquid crystal display comprising:
a lower display substrate including a thin film transistor and a pixel electrode connected thereto;
an upper display substrate facing the lower display substrate; and
a liquid crystal layer disposed between the lower display substrate and the upper display substrate,
wherein the lower display substrate includes:
a data line;
a first color filter and a second color filter configured to cover at least a portion of the data line, the first color filter and the second color filter being disposed to overlap each other on the data line; and
an opaque shielding electrode disposed on the first and second color filters, and covering the data line.

2. The liquid crystal display of claim 1, wherein the opaque shielding electrode is made from a precursor shielding electrode made of a conductive oxide including indium, wherein indium is precipitated. [

3. The liquid crystal display of claim 2, wherein the conductive oxide is indium tin oxide (ITO) or indium zinc oxide (IZO).

4. The liquid crystal display of claim 1, wherein a width of the shielding electrode is wider than that of the data line that is covered by the shielding electrode.

5. The liquid crystal display of claim 1, wherein the pixel electrode includes a first subpixel electrode and a second subpixel electrode,
the first subpixel electrode includes a first subregion and a second subregion, and
the lower display substrate further includes an insulating layer that is disposed on the first subregion and is disposed below the second subregion and the second subpixel electrode.

6. The liquid crystal display of claim 5, wherein the shielding electrode is disposed at a same layer as that of the first subregion.

7. The liquid crystal display of claim 5, wherein the first subregion and the second subregion are connected to each other through a contact hole formed in the insulating layer.

8. The liquid crystal display of claim 1, wherein the lower display substrate further includes a light blocking member.

9. The liquid crystal display of claim 8, wherein the light blocking member is disposed to extend in a direction perpendicular to the data line.

10. The liquid crystal display of claim 8, further comprising a column spacer disposed on the light blocking member and made of a same material as that of the light blocking member.

11. The liquid crystal display of claim 1, wherein the upper display substrate includes a common electrode that generates an electric field together with the pixel electrode.

12. The liquid crystal display of claim 11, wherein a same voltage is applied to the shielding electrode and the common electrode.

13. A manufacturing method of a liquid crystal display, the method including:
forming a data line on a substrate;
forming a first color filter and a second color filter that overlap each other and covering the data line;
forming a pixel electrode and a precursor of a light blocking electrode on the first and second color filters; and
forming an opaque light blocking electrode by performing a plasma treatment on the precursor of the light blocking electrode.

14. The manufacturing method of claim 13, wherein the pixel electrode and the precursor of the light blocking electrode are made of indium tin oxide (ITO) or indium zinc oxide (IZO).

15. The manufacturing method of claim 13, wherein the forming of the opaque light blocking electrode includes generating haze by causing a material inside the precursor of the light blocking electrode to precipitate.

16. The manufacturing method of claim 15, wherein the precipitated material is indium.

17. The manufacturing method of claim 13, wherein the pixel electrode is formed as two layers, and the precursor of the light blocking electrode is formed together with a lower one of the two layers.

18. The manufacturing method of claim 13, wherein the plasma treatment is performed in a reducing atmosphere including hydrogen.

19. The manufacturing method of claim 18, wherein the reducing atmosphere includes N₂ and H₂, and a ratio of N₂:H₂ is about 1:3.

20. The liquid crystal display of claim 1, wherein the opaque shielding electrode extends in the same direction as the data line.
